(19) United States
(12) Patent Application Publication
(10) Pub. No.: US 2024/0044754 A1
(43) Pub. Date: Feb. 8, 2024

(54) METHODS, SYSTEMS, AND DEVICES FOR SAMPLE INTERFACE

(71) Applicant: 10x Genomics, Inc., Pleasanton, CA (US)

(72) Inventors: David Morgan, Castro Valley, CA (US); Denis Pristinski, Dublin, CA (US); Evan Dejarnette, San Francisco, CA (US); Joshua Cataldo, Oakland, CA (US); Yiran Zhang, Castro Valley, CA (US); Zhenping Guan, Pleasanton, CA (US); Adrian Tanner, Oakland, CA (US)

(73) Assignee: 10x Genomics, Inc., Pleasanton, CA (US)

(21) Appl. No.: 18/328,200

(22) Filed: Jun. 2, 2023

Related U.S. Application Data
(60) Provisional application No. 63/348,879, filed on Jun. 3, 2022.

(51) Int. Cl. G01N 1/31

(52) U.S. Cl. CPC G01N 1/312

(57) ABSTRACT

An assembly includes a stage body, a cam plate disposed on the body, and a sample positioning plate having a sample positioning surface configured to receive a sample device. The surface has first, second, and third raised portions. The second raised portion is disposed between the first and third raised portions. The first, second, and third raised portions are configured to contact the sample device. The assembly includes a riser module disposed within the stage body. The riser module is coupled to the plate and the body. The assembly includes a lid configured to be coupled to the cam plate. The lid has a coupled configuration and an uncoupled configuration such that, when in the coupled configuration, a recess is formed by the lid and the plate. The assembly includes one or more light sources disposed in the cam plate that are configured to direct light within the recess.

### CROSS-REFERENCE

The present application is a non-provisional of 63/348,879, filed Jun. 3, 2022, entitled “Methods, Systems, and Devices for Sample Interface,” which application is herein incorporated by reference in its entirety for all purposes.

### FIELD OF THE INVENTION

The present disclosure is directed to methods, systems, and devices for sample interface. In particular, the present disclosure describes sample interface devices and systems that are configured to secure a sample (e.g., a biological sample) in an analysis instrument (e.g., an in situ analysis instrument).

### BACKGROUND

In situ analysis may be used to detect the presence of target molecules (e.g., RNA, DNA, proteins, antibodies, etc.) in their naturally-occurring three-dimensional locations (i.e., in situ) within a sample (e.g., a biological sample). In preparation for in situ analysis, a sample may be positioned on a substrate (e.g, a glass slide) or the sample may have been previously positioned on a substrate and stored. The substrate (having the sample thereon) is then secured in an in situ analysis system so that the sample may be repeatedly probed and imaged for the presence of the target molecules. Motion of the sample should be minimized to allow for accurate image processing, such as image registration and/or image stitching. Accordingly, there exists a need for methods, systems, and devices to interface the sample with an in situ analysis system, thereby securing the sample for imaging, providing a volume for probing reagents, providing edge lighting of the sample.

### BRIEF DESCRIPTION OF THE DRAWINGS

FIGS. 1A-1I illustrate a sample interface module in an open configuration according to embodiments of the present disclosure. FIGS. 1A-1B are perspective views of a sample interface module in an open configuration. FIG. 1C is a zoomed in view of a portion of the sample interface module. FIG. 1D is a top view of a sample interface module in an open configuration. FIGS. 1E-1H are side views of a sample interface module in an open configuration. FIG. 11 is a bottom view of a sample interface module in an open configuration.

FIGS. 2A-2H illustrate a sample interface module in a closed configuration having a cassette secured therein according to embodiments of the present disclosure. FIGS. 2A-2B are perspective views of a sample interface module in a closed configuration. FIG. 2C is a top view of a sample interface module in a closed configuration. FIGS. 2D-2G are side views of a sample interface module in a closed configuration. FIG. 2H is a bottom view of a sample interface module in a closed configuration.

FIG. 3 illustrates a cross section of a sample interface module in a closed configuration according to embodiments of the present disclosure.

FIGS. 4A-4H illustrate a sample device according to embodiments of the present disclosure.

FIGS. 5A-5H illustrates a carrier for sample interface modules according to embodiments of the present disclosure. FIGS. 5A-5B are perspective views of a carrier for sample interface modules. FIGS. 5C-5F are side views of a carrier for sample interface modules. FIG. 5G is a top view of a carrier for sample interface modules. FIG. 5H is a bottom view of a carrier for sample interface modules.

FIGS. 6A-6C illustrate a carrier (without the top cover) for sample interface modules according to embodiments of the present disclosure.

FIGS. 7A-7G illustrate a gasket for a sample device according to embodiments of the present disclosure.

FIG. 8 illustrates a leak sensor of a sample interface module according to embodiments of the present disclosure.

FIGS. 9A-9E illustrate a riser and leveling subassembly according to embodiments of the present disclosure.

FIGS. 10A-10C illustrate an optical wetting consumable and waste container subassembly according to embodiments of the present disclosure.

### DETAILED DESCRIPTION

In situ analysis may be used to detect the presence of target molecules (e.g., RNA, DNA, proteins, antibodies, etc.) in their naturally-occurring three-dimensional locations (i.e., in situ) within a sample (e.g., a biological sample). In preparation for in situ analysis, a sample may be positioned on a substrate (e.g, a glass slide) or the sample may have been previously positioned on a substrate and stored. The substrate (having the sample thereon) is then secured in an in situ analysis system so that the sample may be repeatedly probed and imaged for the presence of the target molecules. During in situ analysis, the sample may be repeatedly probed with a variety of probes configured to indicate the presence of a target molecule or molecules. During probing, reagents may be delivered to or extracted from a volume around the sample. Optionally or additionally, a temperature of the sample may be adjusted as needed for reactions during probing. Additionally, probes may require excitation during imaging via, for example, one or more sources of light where each source of light has a predetermined wavelength emission profile configured to excite one or more probes. Moreover, during the imaging process, edge lighting may be provided for various imaging purposes, such as, for example, bounds detection of the sample and/or determination of a focal plane for an imaging objective. Motion of the sample should be minimized to allow for accurate image processing, such as image registration and/or image stitching. Accordingly, there exists a need for methods, systems, and devices to interface the sample with an in situ analysis system, thereby securing the sample for imaging, providing a volume for probing reagents, providing edge lighting of the sample.

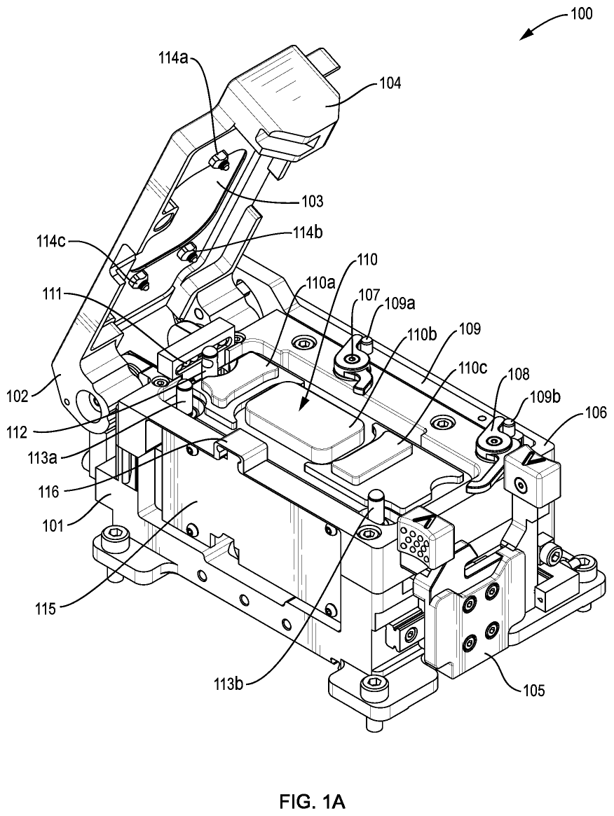

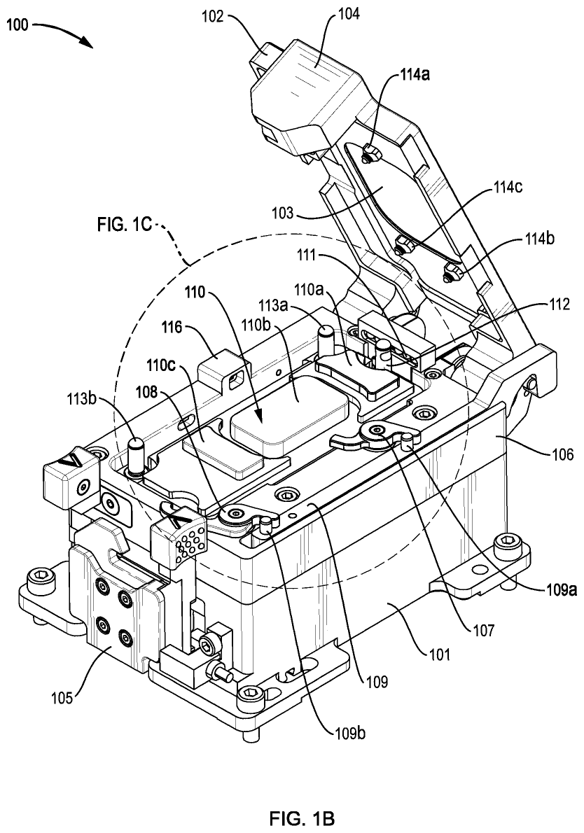

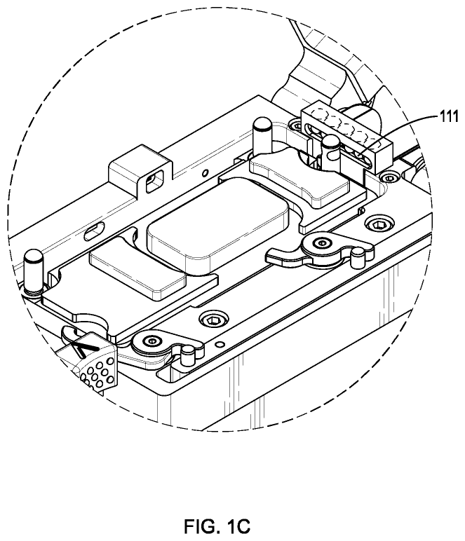

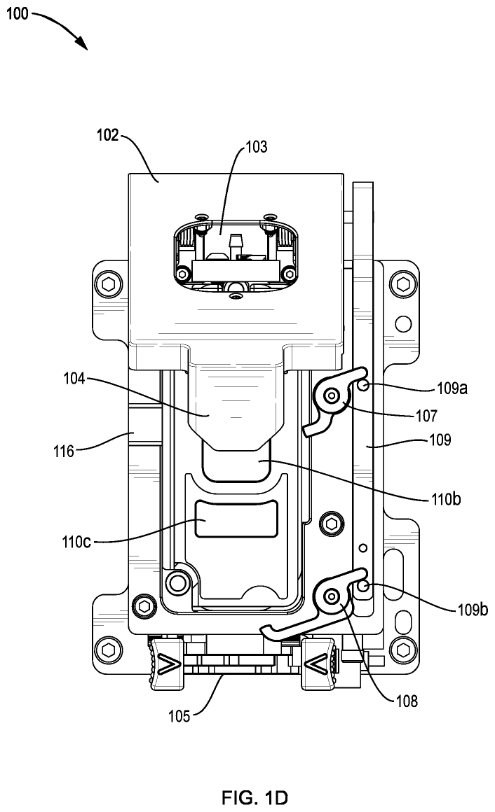

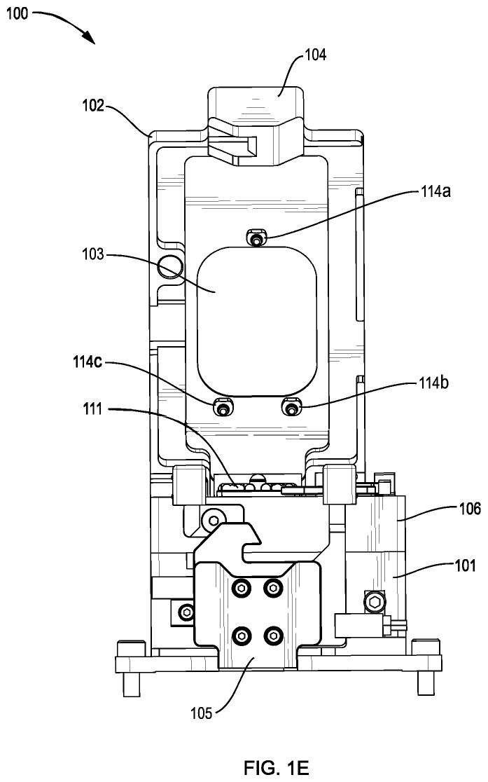

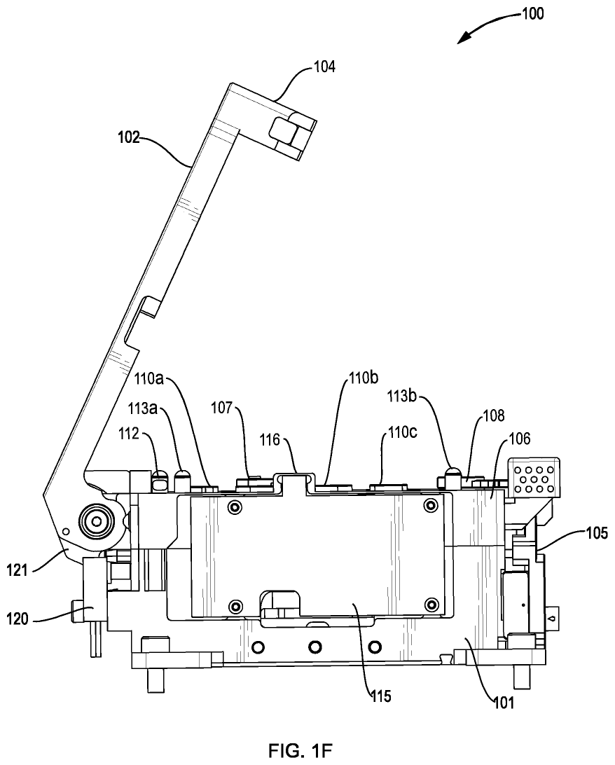

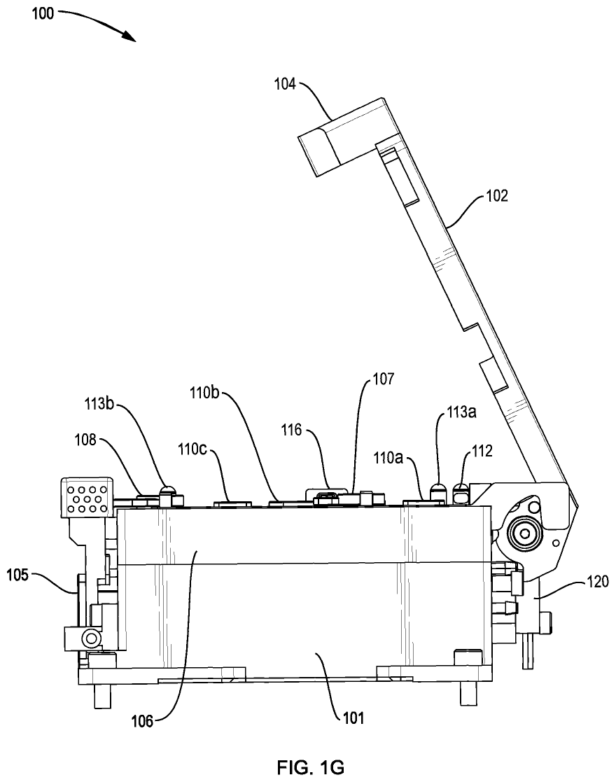

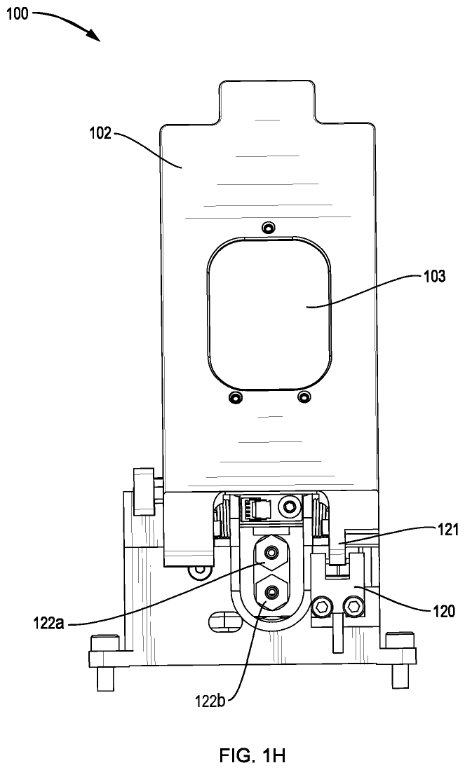

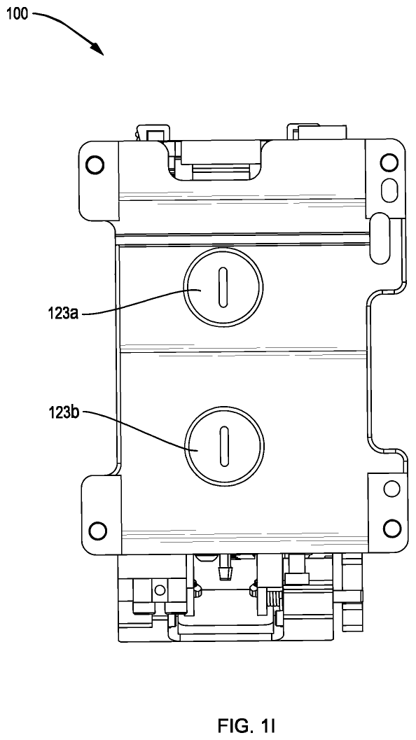

FIGS. 1A-1I illustrate a sample interface module (SIM) 100 in an open configuration. As shown in FIG. 1A, the SIM 100 includes a stage body 101 and a lid 102 having an aperture 103 and a latch 104.

As illustrated in FIG. 1A, the lid 102 is in the open configuration. The SIM 100 further includes a catch 105 configured to couple to the latch 104 of the lid 102. In various embodiments, the catch 105 is coupled to the stage body 101. The SIM 100 further includes a cam plate 106 disposed on the stage body 101. In various embodiments, the lid 102 is hingedly coupled to the cam plate 106 at a first end and has the latch 104 on the second end. In various embodiments, the lid 102 is hingedly coupled to the stage body 101. The cam plate 106 includes an X cam 107 configured to provide an X-direction force on a sample device (e.g., a cassette) and a Y cam 108 configured to provide a Y-direction force on the sample device. The X cam 107 and the Y cam 108 are rotatably coupled to the cam plate 106 such that each of the cams 107, 108 rotate about an axis that is perpendicular to an XY plane defined by the X direction and the Y direction. In various embodiments, the X cam 107 and/or Y cam 108 may be spring loaded. In various embodiments, the X cam 107 and/or Y cam 108 may include a soft material (e.g., rubber cap) to reduce concentrated point forces on the sample device. The SIM 100 further includes a cam pusher 109 coupled to the lid 102. In various embodiments, the cam pusher 109 is disposed within the cam plate 106. In various embodiments, the cam pusher 109 is configured to linearly translate within the cam plate 106 as the lid is opened or closed. In various embodiments, the cam pusher 109 includes one or more pins configured to rotate each cam 107, 108. For example, the cam pusher 109 includes a first pin 109a configured to rotate the X cam 107 and a second pin 109b configured to rotate the Y cam 108.

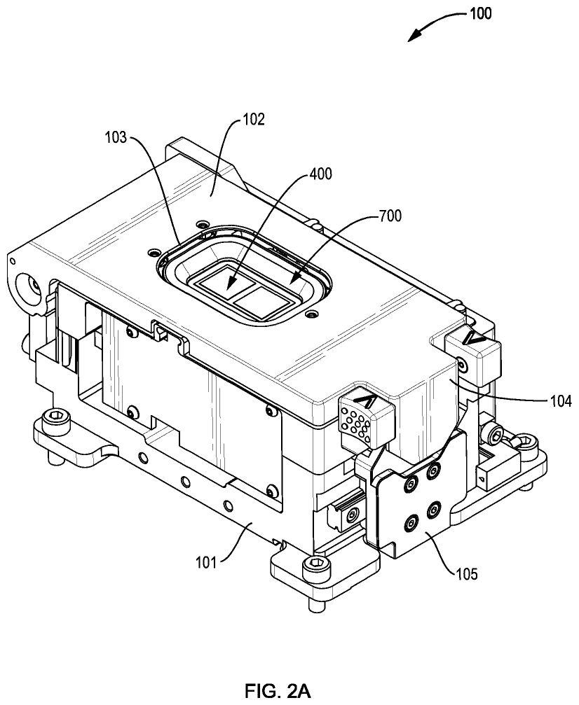

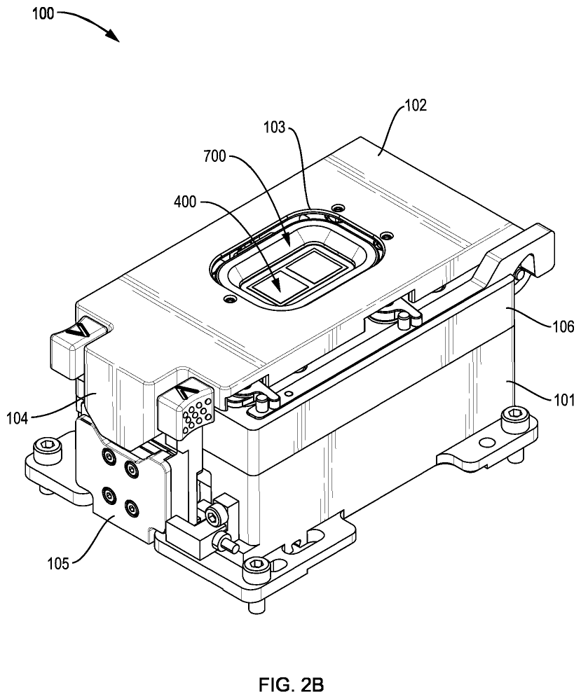

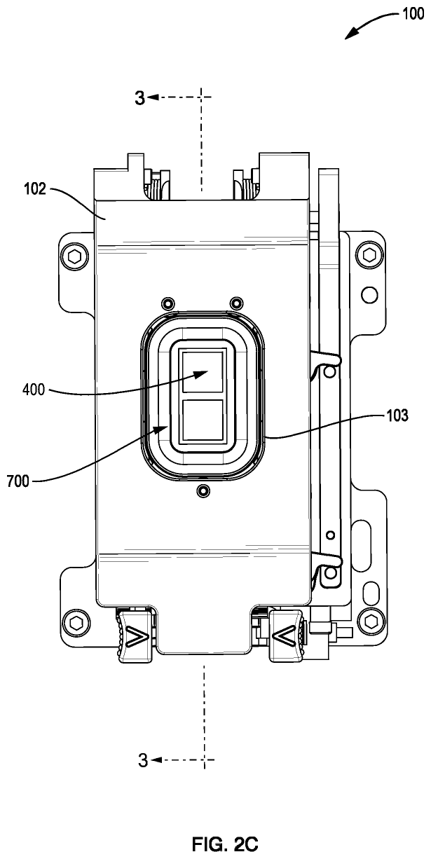

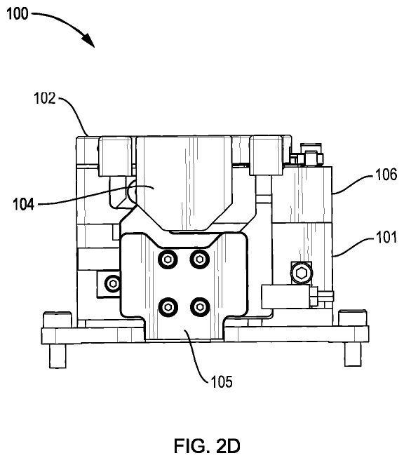

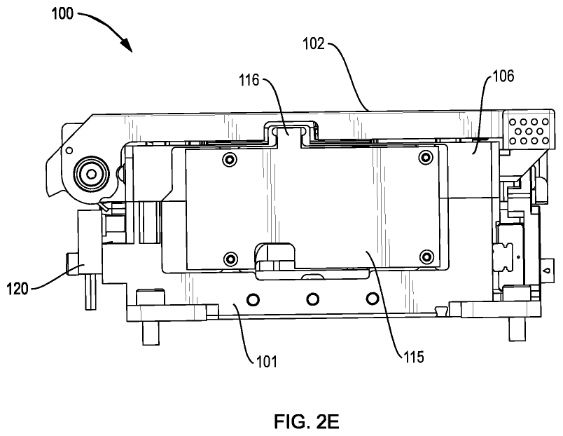

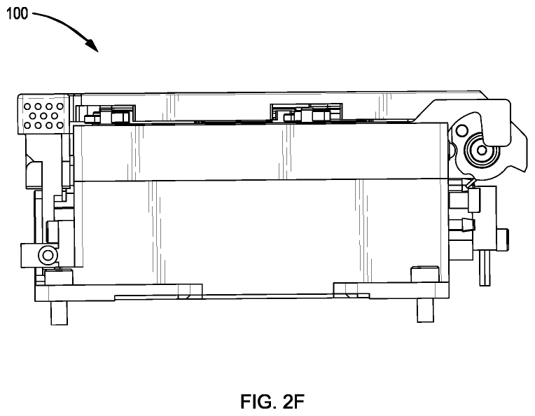

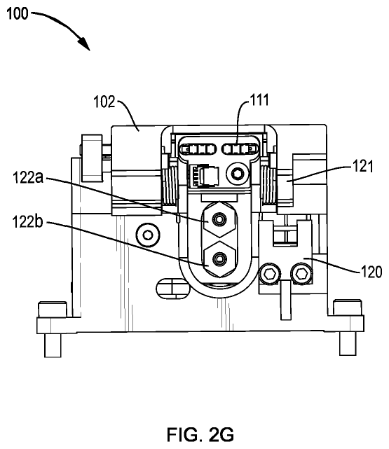

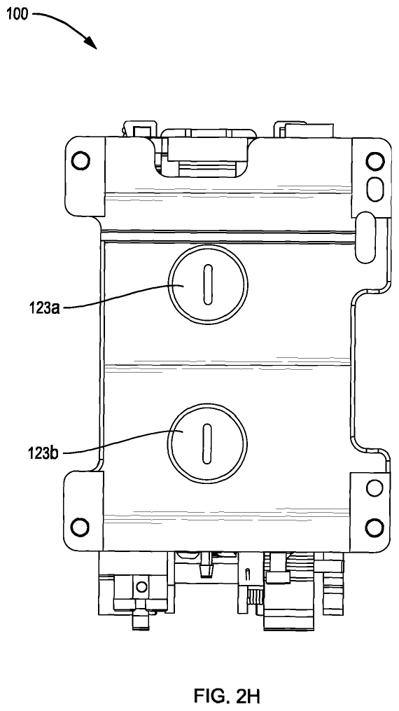

As shown in FIGS. 1A-1I, the SIM 100 further includes a sample positioning plate 110 disposed within the cam plate 106. As will be described in more detail below, the sample positioning plate 110 is coupled to a z-riser module configured to provide a spring force on the sample device in a z-direction. The sample positioning plate 110 includes one or more raised portions configured to be received by apertures in the bottom of the sample device. In various embodiments, the one or more raised portions have complementary shapes (e.g., perimeters) to the perimeters of the apertures in the bottom of the sample device. For example, the sample positioning plate 110 includes a first raised portion 110a, a second raised portion 110b, and a third raised portion 110c. The second raised portion 110b is disposed between the first raised portion 110a and the third raised portion 110c. In various embodiments, the raised portions 110a-110c each have sample positioning surfaces (e.g., a substantially flat surface configured to be in contact with the sample device) defined by planes that are coplanar with one another. In various embodiments, the planes of the sample positioning surfaces are parallel to a plane defined by the lid 102 when the lid is in the closed configuration shown in FIGS. 2A-2H. In various embodiments, the second raised portion 110b has a larger surface area than the surface areas of the first raised portion 110a and/or the third raised portion 110c. In various embodiments, the second raised portion 110b has a larger volume than the volumes of the first raised portion 110a and/or the third raised portion 110c. In various embodiments, the sample positioning plate 110 may be fabricated of a material having high thermal conductivity. For example, the material may be a metal (e.g., stainless steel, aluminum, etc.).

In various embodiments, the SIM 100 further includes one or more light sources 111. In various embodiments, the one or more light sources are light emitting diodes (LEDs). In various embodiments, the one or more light sources are disposed within a housing extending from the cam plate 106. In various embodiments, the one or more light sources 111 are positioned to direct light towards the raised portions 110a-110c. In various embodiments, the one or more light sources 111 are configured to provide edge lighting to a sample (e.g., a biological sample) positioned on the sample device (e.g., a cassette). In various embodiments, the one or more light sources 111 comprise red lights (e.g. about 620 nm to about 750 nm). In various embodiments, the one or more light sources 111 comprise green lights (e.g. about 475 nm to about 570 nm). In various embodiments, the one or more light sources 111 comprise blue lights (e.g. about 450 nm to about 495 nm). In various embodiments, the one or more light sources 111 are configured for adjustable intensity of illumination.

In various embodiments, edge lighting (e.g., via one or more LEDs) can couples light to a wave guide, such as the glass substrate on which the sample is positioned. In various embodiments, the wave guide is a separate device positioned underneath the glass substrate. Systems and methods for transillumination of samples (e.g., using edge lighting) is described in PCT/US2023/060857, which is incorporated by reference herein in its entirety. In various embodiments, the wave guide receives photons of light through at least one side surface. In various embodiments, to facilitate a more uniform distribution of light exiting the top surface of the waveguide, the bottom surface of the waveguide includes a light scattering layer. In various embodiments, the light scattering layer is a coating. In various embodiments, the light scattering layer includes at least one metal oxide (e.g., alumina, titania) nanoparticles dispersed within an epoxy matrix. In various embodiments , nanoparticles cause the light to scatter in random directions and makes the resulting illumination more uniform through the top surface of the waveguide. In various embodiments, the nanoparticles have a mean diameter of about 500 nm. In various embodiments, the nanoparticles have a mean diameter of about 550 nm. In various embodiments, the nanoparticles have a mean diameter of about 600 nm. In various embodiments, the nanoparticles have a mean diameter of about 400 nm to about 600 nm. In various embodiments, the nanoparticles have a mean diameter of about 500 nm to about 600 nm. In various embodiments, the nanoparticles have a mean diameter of less than about 600 nm. In various embodiments, the nanoparticles have a mean diameter of less than about 500 nm. In various embodiments, the waveguide includes at least one reflective layer and/or coating (e.g., silvered) on one or more sides to limit the amount of light that leaks out from the sides that do not receive the edge lighting. In various embodiments, photons of light are received by the waveguide, scattered by the light scattering layer on the bottom, and exit through the top of the waveguide.

In various embodiments, the cam plate 106 further includes a Y pin 112 and X pins 113a-113b configured to align and/or secure the sample device when the sample device is positioned on the sample positioning plate 110. In various embodiments, the Y pin 112 provides a reaction force in response to a force applied to the sample device by the Y cam 108 to thereby secure the sample device in the Y direction. In various embodiments, the X pins 113a-113b provide a reaction force in response to a force applied to the sample device by the X cam 107 to thereby secure the sample device in the X direction. In various embodiments, the lid 102 includes one or more Z pins 114a-114c configured to provide a force in the Z direction on the sample device when the lid 102 is in the closed configuration. In various embodiments, as the lid 102 is closed and the Z pins 114a-114c engage the sample device, the z-riser module will provide a reaction spring force to thereby secure the sample device in the Z direction. In various embodiments, the Z pins 114a-114c engage the sample device by directly contacting the glass substrate on the bottom and/or the top surfaces to thereby minimize (e.g., prevent) bending of the glass substrate. In various embodiments, bending of the glass substrate can cause distortion during imaging. In various embodiments, the Z pins provide point contact on the top surface of the glass substrate. It should be noted that the Z pins could engage any part of the sample device to secure the glass slide.

In various embodiments, the SIM 100 further includes a control board 115 (e.g., a printed circuit board) configured to control the electronic components of the SIM 100 (e.g., the light sources 111). In various embodiments, the SIM 100 further includes a sensor 116. In various embodiments, the sensor comprises a photodetector. In various embodiments, the photodetector is an infrared (IR) sensor. In various embodiments, the sensor 116 is directed towards at least one of the raised portions 110a-110c. In various embodiments, the sensor 116 is configured to detect the presence of the sample device positioned on the sample positioning plate 110. In various embodiments, the cam plate 106 includes a sensor housing configured to house the sensor 116.

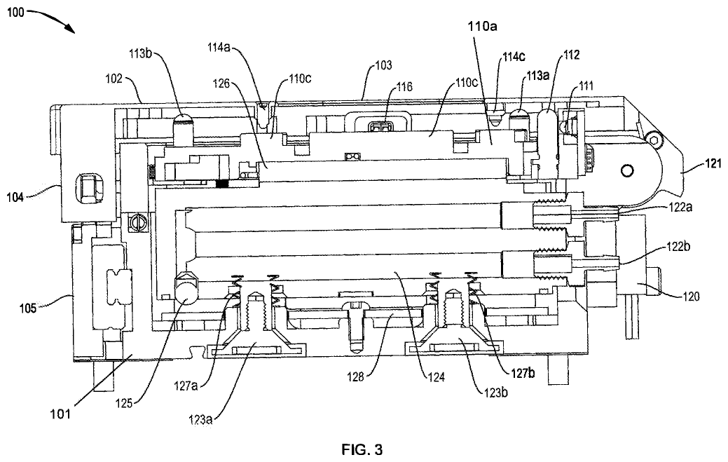

As shown in FIGS. 1F-1H, the SIM 100 further includes a sensor 120 configured to detect whether the lid 102 is open or closed. In various embodiments, the lid 102 may include a projection 121 that is detected by the sensor 120 (e.g., the projection 121 may obstruct a signal of the sensor 120) while the lid 102 is open. When the lid 102 is closed, the projection 121 may not be detected by the sensor 120 (e.g., the projection 121 may not obstruct a signal of the sensor 120). In various embodiments, as shown in FIG. 1H, the SIM 100 includes a fluid circuit having an inlet 122a and an outlet 122b configured for thermal management of the thermoelectric module, as will be described in more detail in FIG. 3.

FIGS. 2A-2H illustrate a SIM 100 in a closed configuration having a sample device 400 secured therein. As shown in FIGS. 2A-2H, the lid 102 is closed and the latch 104 is coupled to the catch 105. In various embodiments, the aperture 103 of the lid 102 forms a recess when the lid 103 is in the closed configuration. In various embodiments, the sample device is secured in the recess. In various embodiments, the recess is formed by at least a portion of the lid, at least a portion of the sample positioning plate 110, and/or at least a portion of the cam plate 106.

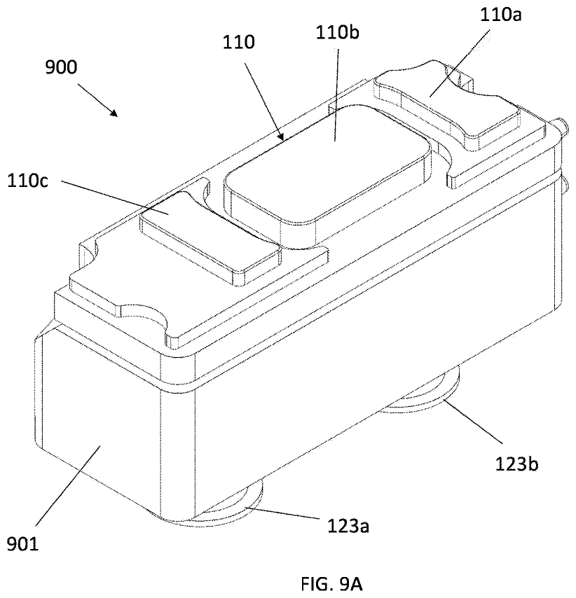

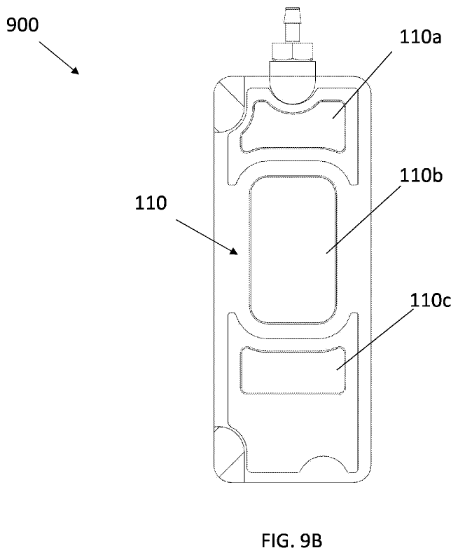

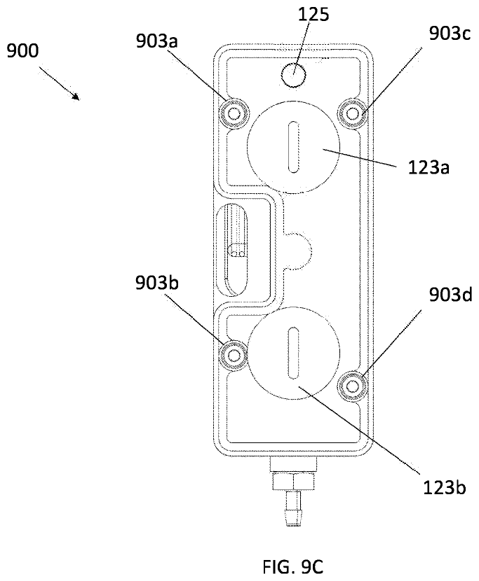

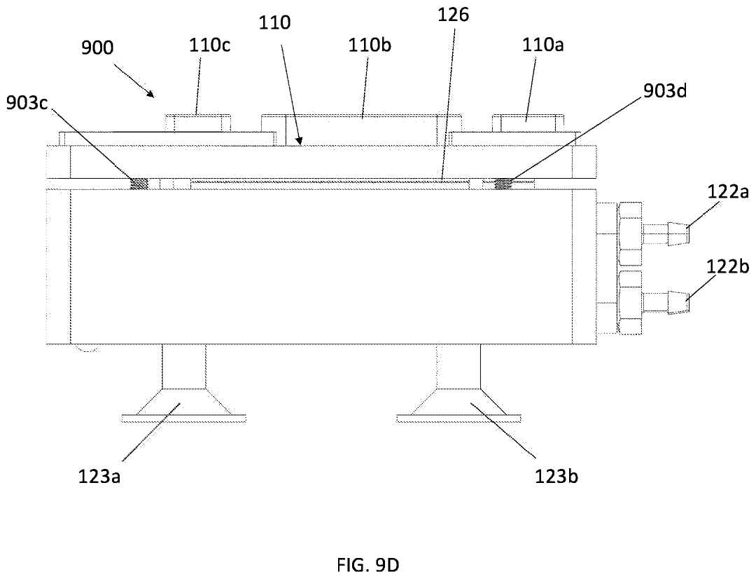

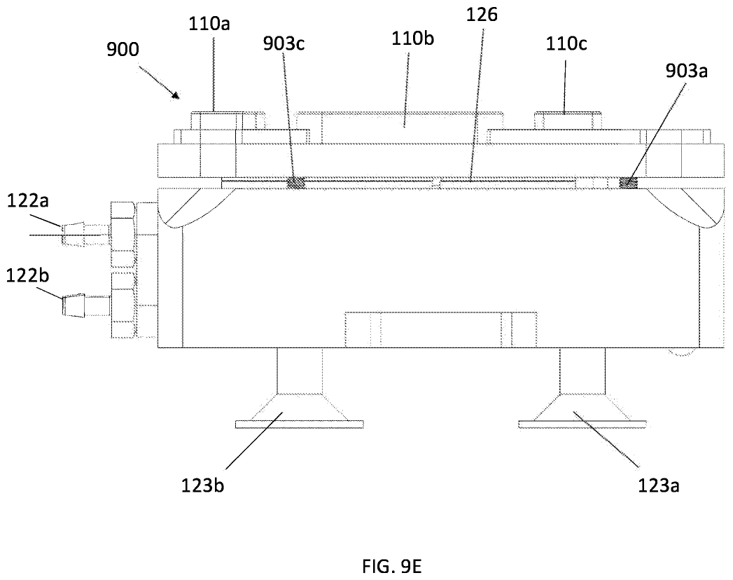

FIG. 3 illustrates a cross section of a sample interface module in a closed configuration. In various embodiments, the SIM 100 includes a z-riser module, which is described in more detail with respect to FIGS. 9A-9E. In various embodiments, the z-riser module includes a fluid circuit having an inlet 122a, an outlet 122b, a fluid channel 124, and a relief valve 125 along the channel 124. In various embodiments, the fluid circuit may flow a working fluid therethrough to adjust a temperature of (e.g., heat or cool) the SIM 100. In various embodiments, the relief valve 125 may be configured to open when a threshold pressure is exceeded. In various embodiments, the relief valve 125 may prevent backflow of the working fluid. In various embodiments, if working fluid is released through the relief valve, the fluid will activate a leak sensor 128. In various embodiments, if probing and/or imaging reagents leak through the sample device, the reagents may activate the leak sensor 128. When the leak sensor 128 detects a leak, the imaging process may be stopped and/or the user may be notified that a leak occurred in the SIM 100.

In various embodiments, the SIM further includes a temperature control apparatus 126. In various embodiments, the temperature control apparatus 126 is one or more thermoelectric modules. In various embodiments, the temperature control apparatus 126 is disposed between the z-riser module and the sample positioning plate 110. In various embodiments, the temperature control apparatus 126 contacts the sample positioning plate 110 (e.g., the bottom of the plate) below at least a portion of each raised portion 110a-110c. As shown in FIG. 3, the temperature control apparatus 126 is positioned below the entirety of the second raised portion 110b and below only a portion of the first raised portion 110a and the third raised portion 110c. In various embodiments, the temperature control apparatus 126 is configured to provide a uniform temperature across an imaging area or imaging volume. For example, the temperature control apparatus 126 conducts heat to each of the raised portions 110a-110c to thereby provide a substantially uniform temperature within the well formed by the substrate and the gasket within the sample device 400.

In various embodiments, the z-riser module is coupled to the stage body 101 via one or more screws 123a, 123b. In various embodiments, the SIM 100 further includes one or more springs 127a, 127b (e.g., compression springs, wave springs, etc.) between the stage body 101 and the z-riser module. In various embodiments, the screws 123a, 123b pass through the springs 127a, 127b. In various embodiments, rotating the screws 123a, 123b thereby adjusts a preloaded spring force on the z-riser module. For example, tightening the screws 123a, 123b increases the preloaded force on the z-riser module.

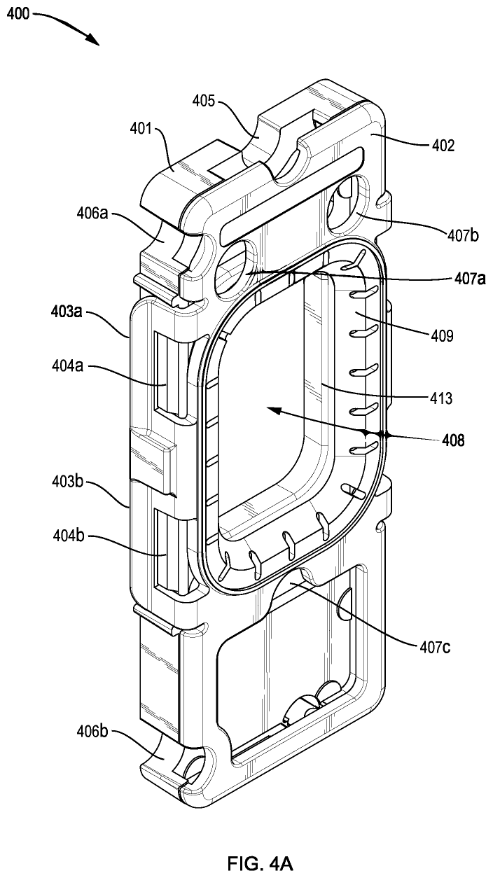

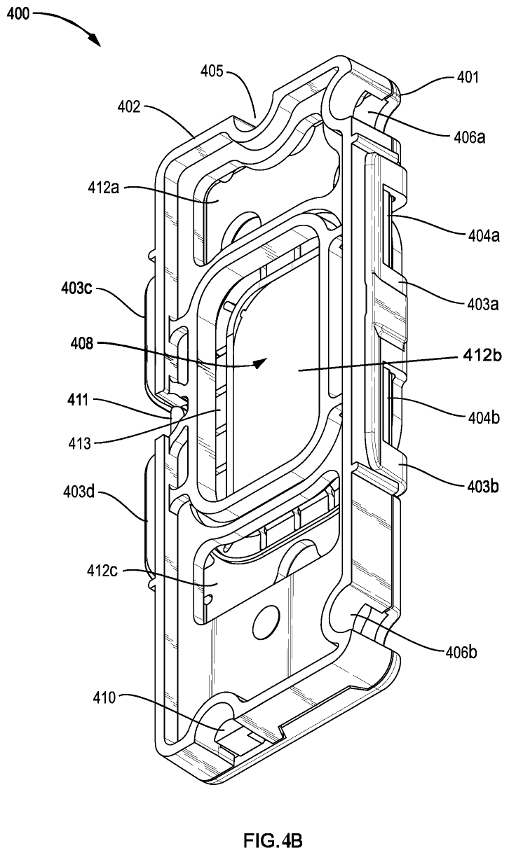

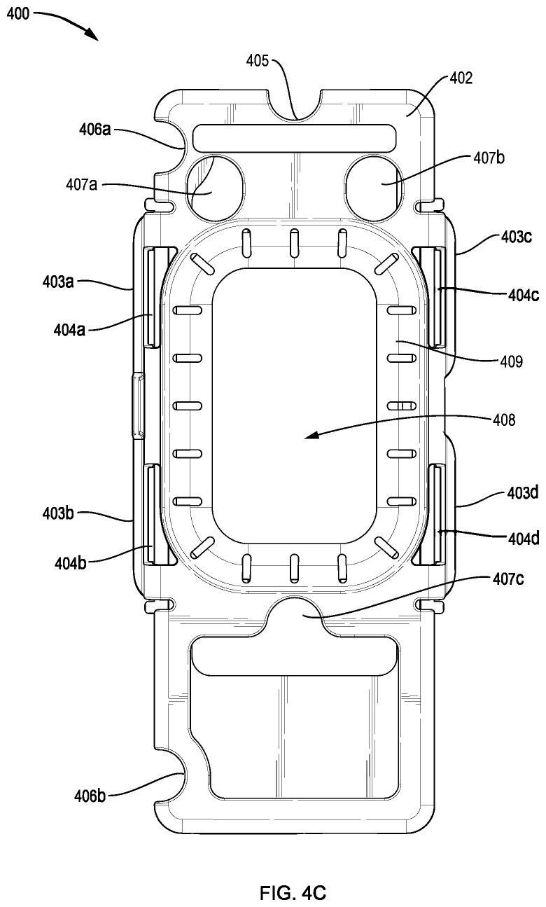

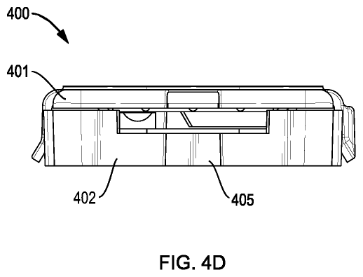

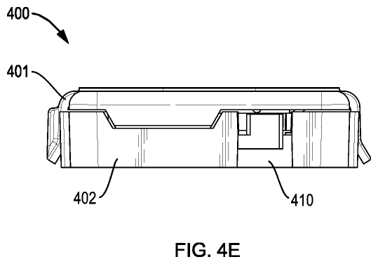

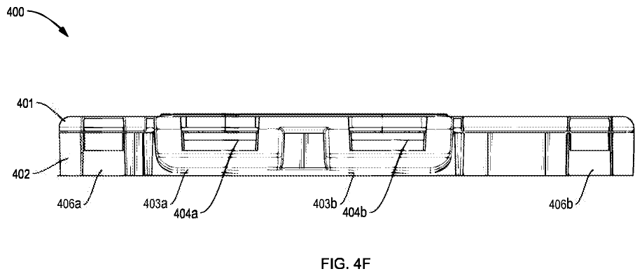

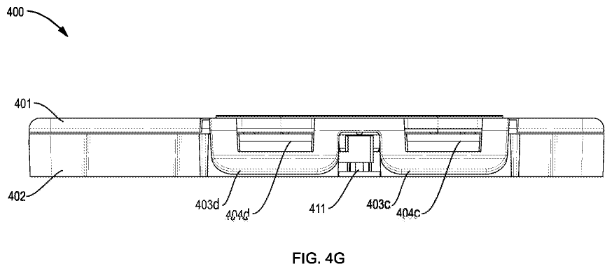

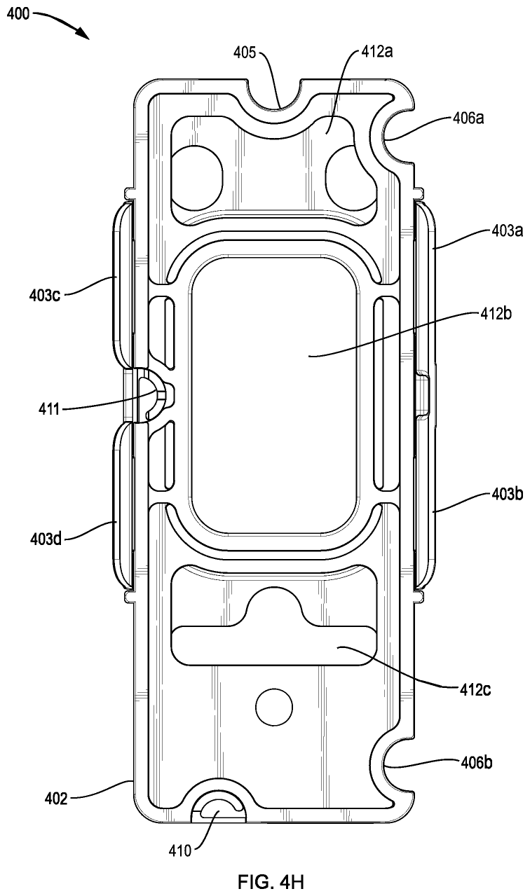

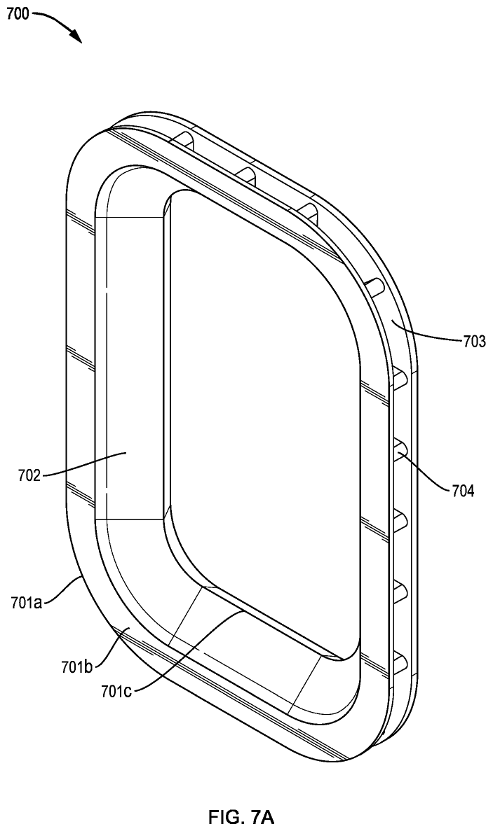

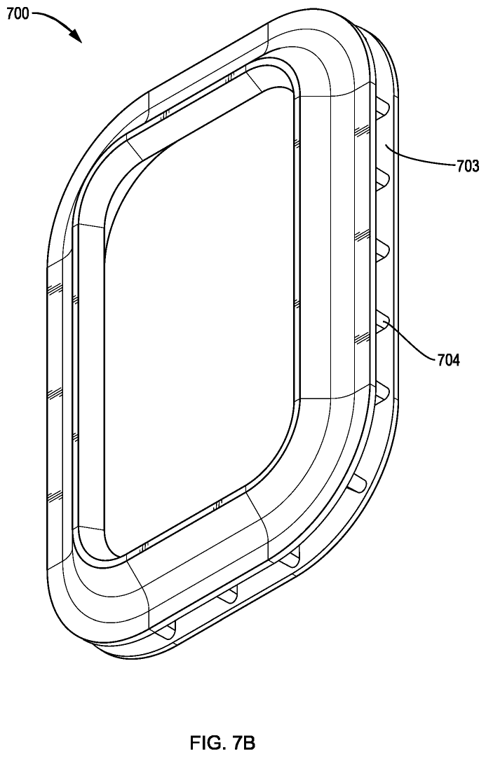

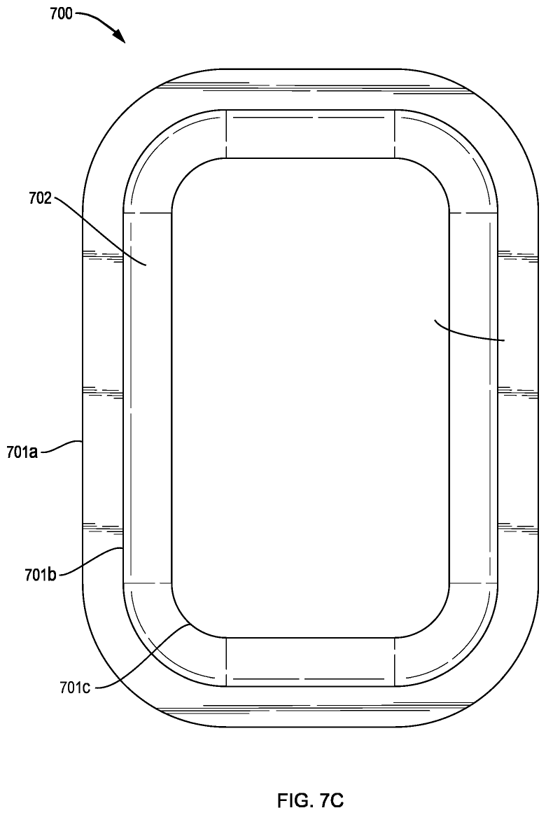

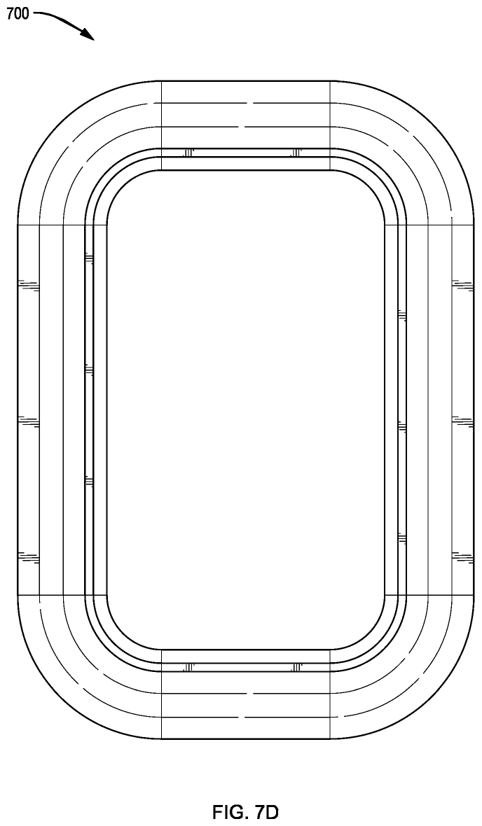

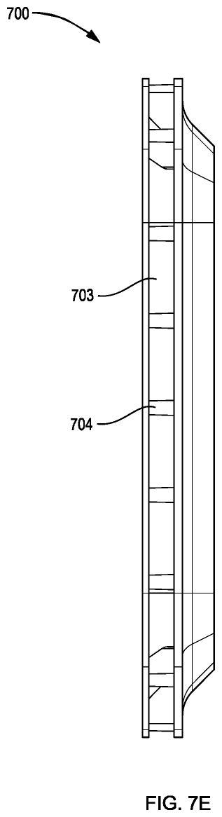

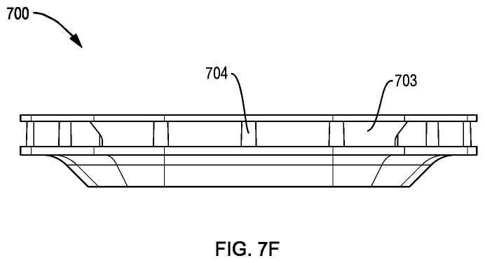

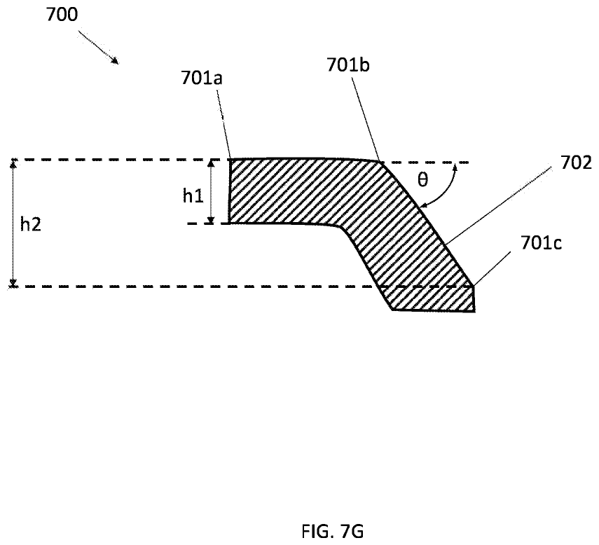

FIGS. 4A-4H illustrate a sample device 400. In various embodiments, the sample device 400 is a cassette. In various embodiments, the sample device 400 includes a bottom portion 401 and a top portion 402. In various embodiments, the top portion 402 has one or more snap joints 403a-403d (e.g., a cantilevered snap joint) configured to couple to lugs 404a-404d (cantilevered lugs) of the bottom portion 401. In various embodiments, the bottom portion 402 may have the snap joints while the top portion has the lugs. In various embodiments, the sample device 400 includes a recess 405 configured to receive the Y pin 112 of the SIM 100. In various embodiments, the sample device 400 includes recesses 406a-406b configured to receive the X pins 113a-113b of the SIM 100. In various embodiments, the sample device 400 includes apertures 407a-407c configured to receive the Z pins 114a-114c on the lid. The Z pins 114a-114c may be configured to contact a substrate (e.g., a glass slide) positioned within (e.g., sandwiched between) the bottom portion 401 and the top portion 402 in the gap 413. When the substrate (not shown) is positioned within the sample device 400, a well 408 is formed between the substrate and the gasket 700, which is described in more detail in FIGS. 7A-7G. In various embodiments, the sample device 400 includes a recess 410 configured to receive the Y cam 108. In various embodiments, the sample device 400 includes a recess 411 configured to receive the X cam 107. In various embodiments, the recesses 410, 411 may include a soft material (e.g., silicone insert, rubber insert, etc.) to prevent concentrated point forces from the cams that may damage the sample device 400. Along a periphery of the well 408, the top portion 402 includes ridges 409 configured to secure a gasket (not shown) therein to thereby form a seal between the substrate and the top portion 402 of the sample device 400.

In various embodiments, the sample device 400 includes apertures 412a-412c configured to receive the raised portions 110a-110c of the sample positioning plate 110. As illustrated, for example, apertures 412a and 412c can be on either side of aperture 412b. In various embodiments, the shape of the perimeters of the apertures 412a-412c are complementary to the shape of the perimeters of the respective raised portions 110a-110c. In various embodiments, the apertures 412a-412c are slightly larger than the raised portions 110a-110c to allow for receiving of the raised portions 110a-110c.

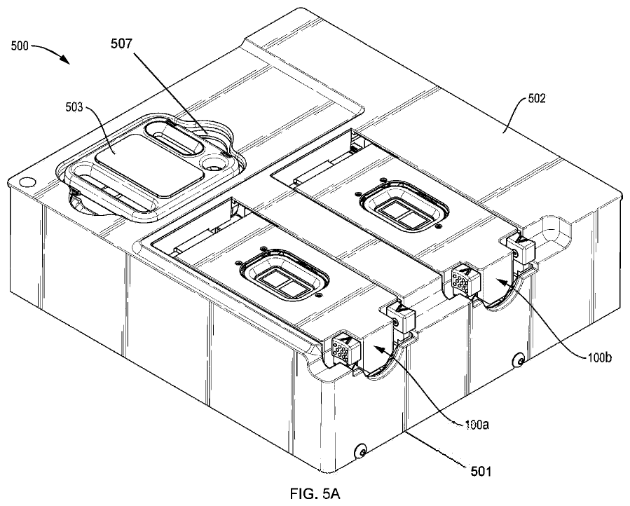

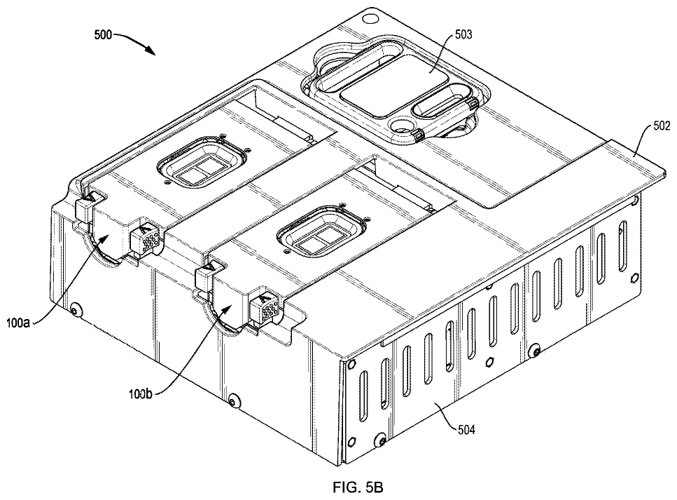

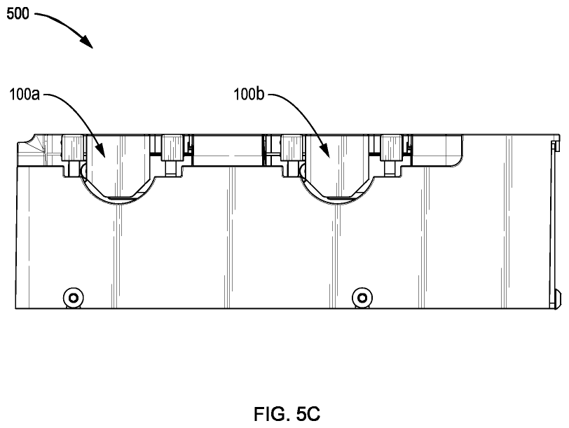

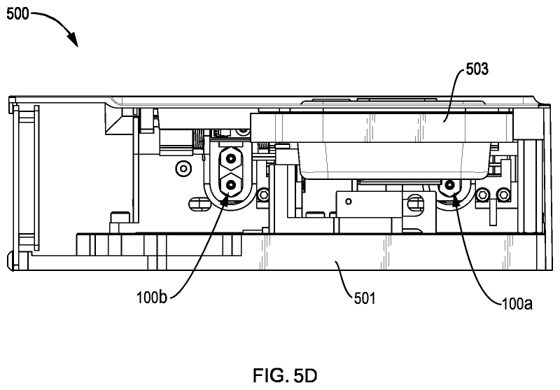

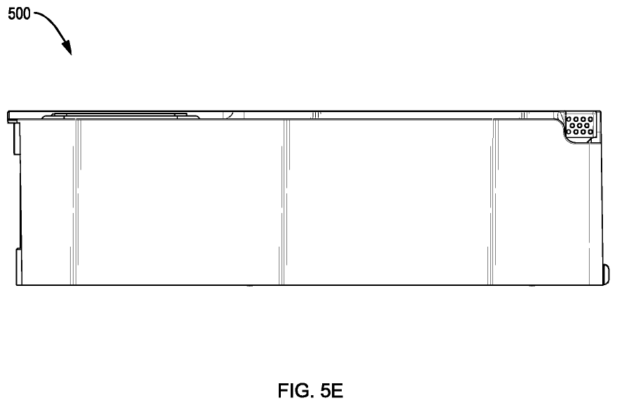

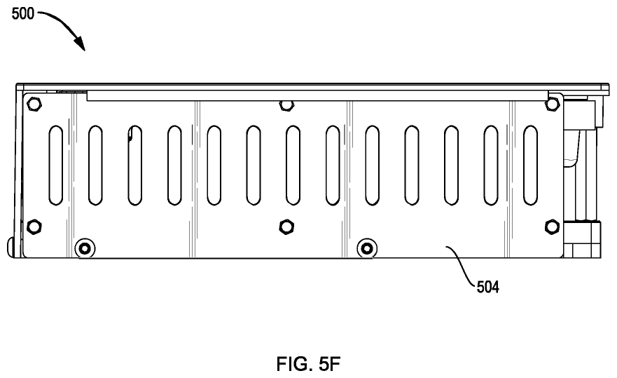

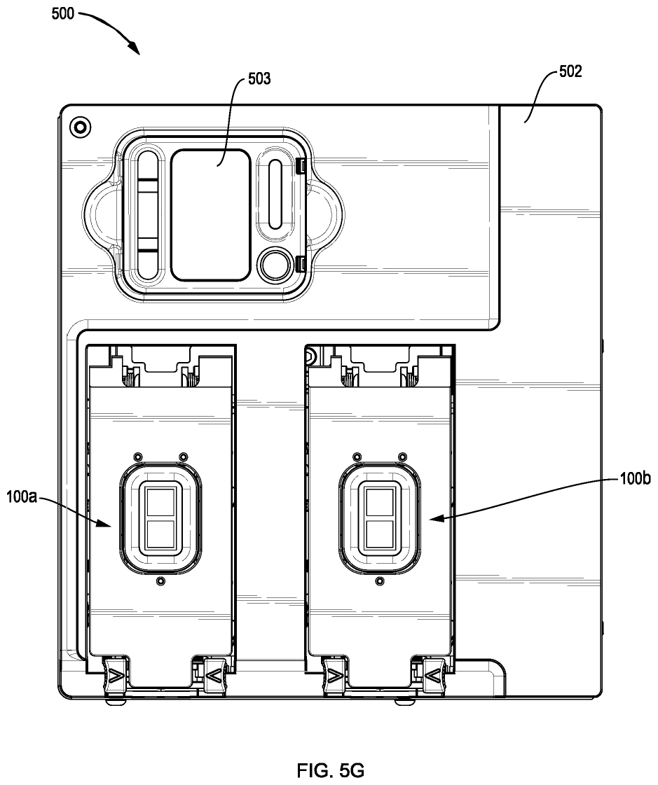

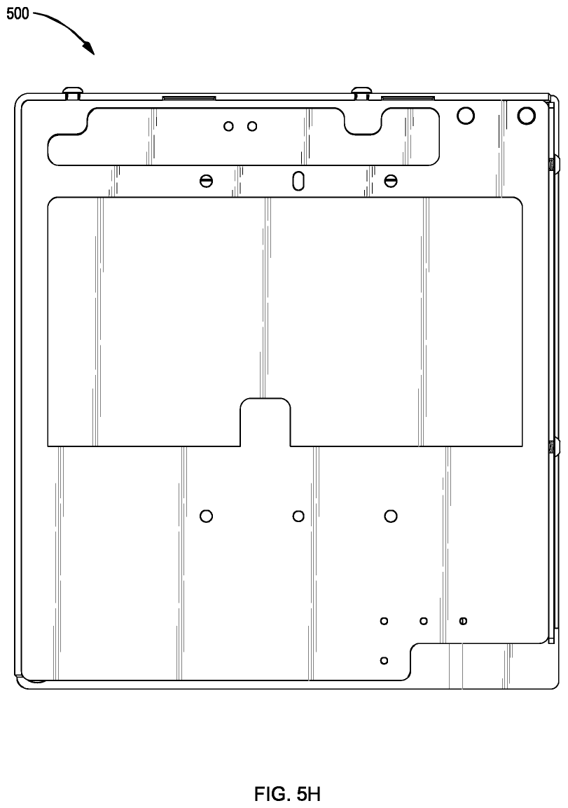

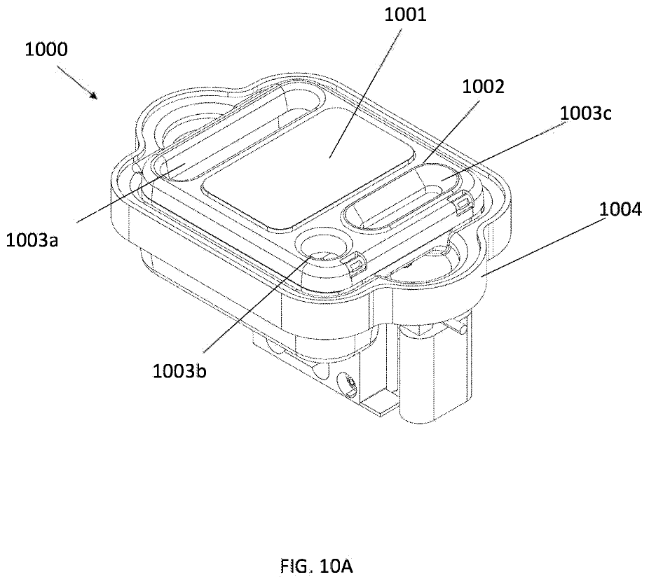

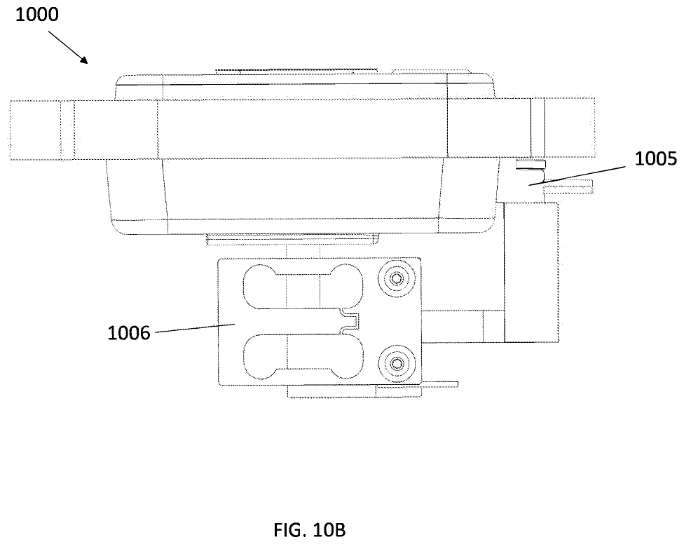

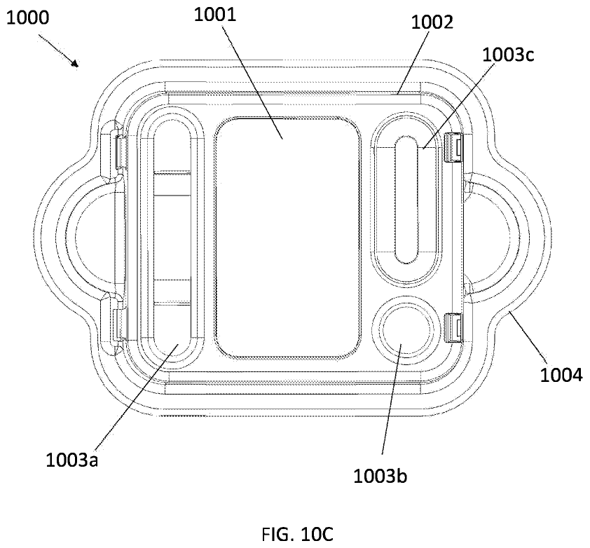

FIGS. 5A-5H illustrates a carrier 500 for sample interface modules 100a, 100b. As shown in FIG. 5A-5H, the carrier 500 includes a base 501, a cover 502, an optical wetting consumable (OWC) 503 and waste container 507 subassembly (described below in more detail with respect to FIGS. 10A-10C), a vent panel 504, and a controller 505 (e.g. a printed circuit board).

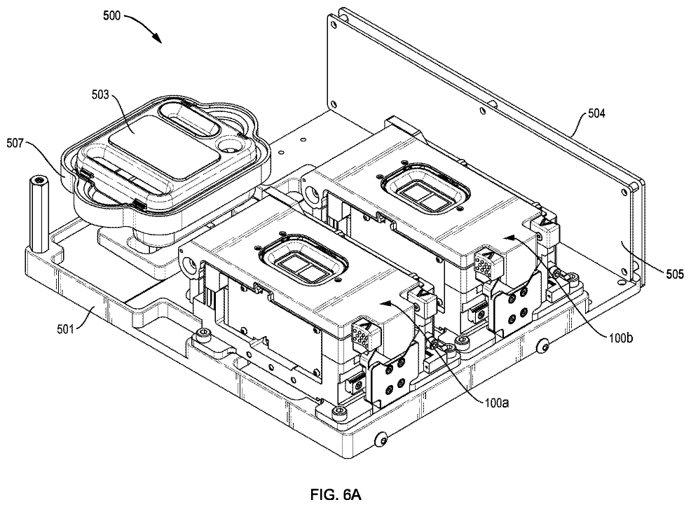

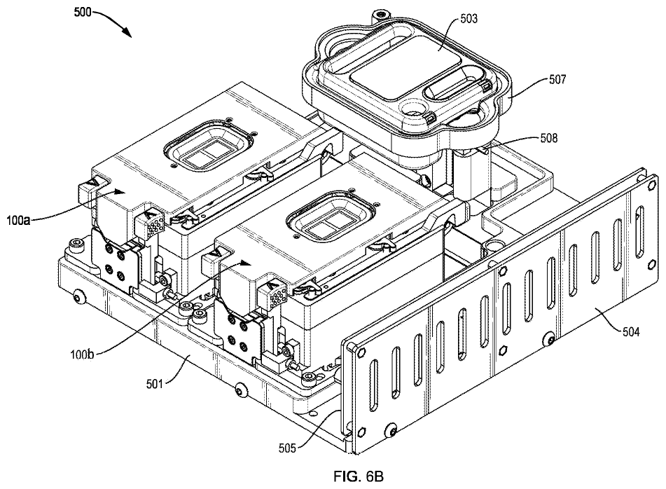

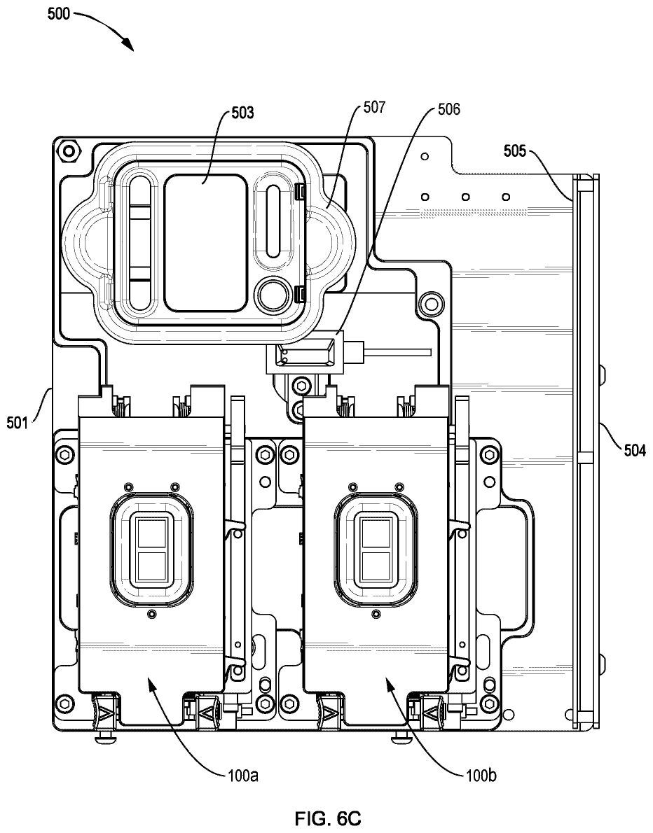

FIGS. 6A-6C illustrate a carrier 500 (without the top cover) for sample interface modules 100a, 100b. In various embodiments, the carrier 500 includes a leak sensor 506 configured to detect fluid that may leak from the waste container 507 and/or the SIMS 100a, 100b. In various embodiments, the carrier 500 includes an OWC sensor 508 (shown in FIGS. 6A-6C) configured to detect the presence of the OWC 503.

FIGS. 7A-7G illustrate a gasket 700 for a sample device 400. As shown in FIGS. 7A-7G, the gasket 700 includes a substantially flat surface defined between a first perimeter 701a and a second perimeter 701b. In various embodiments, the gasket 700 includes a tapered portion 702 between second perimeter 701b and a third perimeter 701c. In various embodiments, the tapered portion 702 has a constant taper. In various embodiments, the tapered portion 702 has a variable taper (e.g., curved taper). In various embodiments, first perimeter 701a has a first width, second perimeter 701b has a second width that is less than the first width, and third perimeter 701c has a third width that is less than the second width. FIG. 7G illustrates a cross-section of the gasket 700 where the gasket 700 includes a height hl (e.g., a thickness) for an upper portion that is substantially flat. In various embodiments, the upper portion includes a gap 703. In various embodiments, the gasket 700 includes one or more vertical ribs 704 disposed within the gap 703. In various embodiments, the tapered portion 702 is tapered over a height h2 and has an angle θ with respect to a horizontal axis. In various embodiments, the angle θ corresponds to (e.g., is equal to) an angle of an exterior of an objective lens to optimize the travel distance of the objective lens and thereby maximize the possible imaging area within the cassette.

FIG. 7H illustrates a cross section of an example gasket device 710 for a sample device 400, in accordance with various embodiments. Gasket 710 can include a substantially flat surface defined between a first perimeter 711a and a second perimeter 711b. In various embodiments, the gasket 710 includes a tapered portion 712 between second perimeter 711b and a third perimeter 711c. In various embodiments, the tapered portion 712 has a constant taper. In various embodiments, the tapered portion 712 has a variable taper (e.g., curved taper). In various embodiments, first perimeter 711a has a first width, second perimeter 711b has a second width that is less than the first width, and third perimeter 711c has a third width that is less than the second width. First perimeter 711a, second perimeter 711b, tapered portion 712, and third perimeter 711c together form an upper portion 713 that merges with a lower portion 715 about a base portion 717.

As illustrated, for example, in FIG. 7H, the upper portion 713 and lower portion 715 together form a gap 719. FIG. 7H also illustrates that lower portion 715 can include a fourth perimeter 721a having a first width, a fifth perimeter 721b having a second width, and a tapered portion 722. Tapered portion 722 can have a constant taper. In various embodiments, tapered portion 722 can have a variable taper (e.g., curved taper). In various embodiments, the slope (or angle θ with respect to a horizontal axis) of tapered portion 722 is the same, or substantially similar, to tapered portion 712. Similarly, in various embodiments, lower portion 715 can be co-planar to upper portion 713.

FIG. 7H further illustrates that upper portion 713 can further include an o-ring 723. O-ring 723 can be configured to extend from an upper surface 725 of upper portion 713. O-ring may sit along any portion of surface 725. FIG. 4H, for example, illustrates o-ring 723 positioned closer to first perimeter 711a than second perimeter 711b. O-ring 723 can be configured to extend from upper surface 725 and along the entire, or along substantially the entire, perimeter of gasket 700.

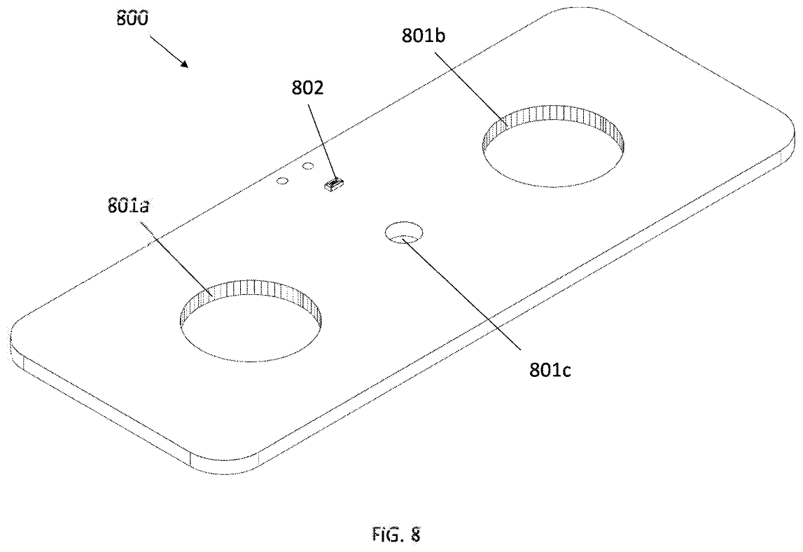

FIG. 8 illustrates a leak sensor 800 of a sample interface module. In various embodiments, the leak sensor 800 includes a conductive material configured to output a predetermined voltage when liquid contacts a surface thereof. For example, the conductive material may include a conductive layer of an integrated circuit having one or more electrodes exposed to air and configured to detect the presence of a liquid that contacts the surface of the conductive layer. In various embodiments, the leak sensor 800 is formed as a thin-film sensor. In various embodiments, the leak sensor 800 is formed as a printed circuit board. In various embodiments, the leak sensor 800 includes one or more serpentine-shaped conductors that extend along the surface of the leak sensor 800. In various embodiments, the one or more serpentine-shaped conductors extend from one end of the leak sensor 800 to the opposite end of the leak sensor 800 such that the conductors extend over substantially all of the surface of the leak sensor 800. In various embodiments, the leak sensor 800 is positioned between the stage body and the z-riser module, as described above. In various embodiments, the leak sensor 800 may include one or more openings 801a-801c to allow fixation elements to pass therethrough. For example, screws connecting the stage body to the z-riser module may pass through openings 801a-801b. In various embodiments, the leak sensor includes a connection 802 for electrical communication with a controller.

FIGS. 9A-9E illustrate a riser and leveling subassembly 900. As shown in FIG. 9A, the riser and leveling subassembly 900 includes a z-riser module 901 coupled to the sample positioning plate 110. As described above with respect to FIGS. 1A-1I, the sample positioning plate 110 includes raised portions 110a-110c configured to be received by apertures of the sample device (e.g., a cassette). In various embodiments, at least a portion (e.g., all) of the surface of each raised portion 110a-110c contacts a glass slide disposed within the sample device. In various embodiments, the z-riser module 901 is coupled to the stage body via one or more screws 123a, 123b. In various embodiments, one or more springs (e.g., compression springs, wave springs, etc.) are disposed between the z-riser module 901 and the stage body to thereby provide a spring reaction force on the z-riser module 901 when the z-riser module 901 is depressed. As described above, the thermal fluid circuit has the inlet 122a and the outlet 122b.

In various embodiments, the z-riser module 901 is coupled to the sample positioning plate 110 via one or more screws. For example, as shown in FIGS. 9C-9E, the z-riser module 901 is coupled to the sample positioning plate 110 via four screws 903a-903d positioned approximately near the four corners of the riser and leveling subassembly 900. In various embodiments, the screws 903a-903d may be configured to level the sample positioning plate 110 during assembly of the sample interface module 100. In various embodiments, a manufacturer may level the sample positioning plate during manufacture so that an end user (e.g., customer) will not have to level the sample positioning plate 110. In various embodiments, a level sample positioning surface includes a substantially flat surface where a plane defined by the flat surface is coplanar with a horizontal plane. As shown in FIG. 9C, the z-riser module 901 further includes a relief valve 125 for the thermal fluid circuit within the z-riser module 901. In various embodiments, the sample positioning plate 110 may be leveled by adjusting (e.g.,. rotating clockwise or counterclockwise) one or more of the screws 903a-903d until the sample positioning plate 110 is substantially flat when installed.

FIGS. 10A-10C illustrate an optical wetting consumable and waste container subassembly 1000. As shown in FIGS. 10A and 10C, the subassembly 1000 includes an optical wetting consumable 1001 disposed in a tray 1002. In various embodiments, the tray 1002 includes one or more apertures 1003a-1003c. In various embodiments, the apertures 1003a-1003c may be configured to receive one or more waste fluids to thereby collect the waste fluid in a waste container 1004. In various embodiments, the apertures 1003a-1003c may be formed as any suitable shape, such as, for example, a circular aperture 1003b or a slot-shaped aperture 1003a, 1003c. In various embodiments, as shown in FIG. 10B, the subassembly includes a sensor 1005 configured to detect the presence of the tray 1002. In various embodiments, the sensor 1005 is an optical sensor. In various embodiments, the subassembly 1000 includes a sensor 1006 configured to detect a mass of the optical wetting consumable 1001. In various embodiments, the sensor 1006 is a load cell.

What is claimed is:

1. An assembly comprising:
a stage body;
a cam plate disposed on the stage body;
a sample positioning plate having a sample positioning surface configured to receive a sample device, wherein the sample positioning surface comprises a first raised portion, a second raised portion, and a third raised portion, wherein the second raised portion is disposed between the first raised portion and the third raised portion, wherein the first raised portion, the second raised portion, and the third raised portion are configured to contact the sample device;
a riser module disposed within the stage body, wherein the riser module is coupled to the sample positioning plate and the stage body;
a lid configured to be coupled to the cam plate, wherein the lid comprises an aperture, wherein the lid has a coupled configuration and an uncoupled configuration such that, when in the coupled configuration, a recess is formed by at least the lid and the sample positioning plate; and
one or more light sources disposed in the cam plate, wherein the one or more light sources are configured to direct light within the recess.

2. The assembly of claim 1, wherein each raised portion comprises a seating surface that is substantially planar.

3-9. (canceled)

10. The assembly of claim 1, further comprising a temperature control apparatus coupled to the sample positioning plate.

11. The assembly of claim 10, wherein the temperature control apparatus is disposed between the sample positioning plate and the riser module.

12-13. (canceled)

14. The assembly of claim 1, wherein the cam plate comprises a light source housing extending therefrom, wherein the one or more light sources are disposed within the light source housing, wherein the light source housing comprises an opening directed at the recess, and wherein the one or more light sources are configured to direct light towards the sample device.

15-21. (canceled)

22. The assembly of claim 1, wherein the recess is further formed by at least a portion of the cam plate.

23. The assembly of claim 20, further comprising a cam pusher operably coupled to the hinge, wherein the cam pusher is configured to translate when the hinge is actuated.

24. (canceled)

25. The assembly of claim 23, further comprising one or more cams rotatably coupled to the cam plate, wherein the sample positioning plate defines a plane, wherein each cam is operably coupled to the cam pusher and configured to rotate about an axis perpendicular to the plane.

26-27. (canceled)

28. The assembly of claim 1, wherein the cam plate comprises one or more pins configured to restrict motion of the sample device in at least one of the x-direction and the y-direction.

29. The assembly of claim 1, wherein the lid comprises one or more pins configured to restrict motion of the sample device in a z-direction, wherein the z-direction is perpendicular to the sample positioning surface.

30. (canceled)

31. The assembly of claim 1, wherein the riser module comprises a fluidic circuit therein.

32. The assembly of claim 1, wherein the raised portions are complementary to apertures in the sample device.

33-39. (canceled)

40. The assembly of claim 1, further comprising at least one screw coupling the sample positioning plate to the riser module, wherein the at least one screw is configured to adjust a plane of the sample positioning plate.

41-42. (canceled)

43. The assembly of claim 1, wherein the sample device comprises a cassette.

44. The assembly of claim 43, wherein the sample device comprises a glass slide disposed in the cassette.

45. (canceled)

46. A method comprising:
providing the assembly of claim 1;
positioning a sample device on the sample positioning plate, thereby engaging each of the first, second, and third raised portions with the sample device;
coupling the lid to the stage body thereby securing the sample device in the recess.

47. The method of claim 46, further comprising a glass slide disposed within the sample device, wherein positioning the sample device comprises contacting the glass slide with the first, second, and third raised portions.

48-52. (canceled)

53. The method of claim 46, further comprising detecting the sample device after positioning on the sample positioning surface.

54. The method of claim 46, further comprising adjusting a pitch, yaw, and/or roll of the sample positioning plate.

55. The method of claim 46, further comprising detecting the presence of a liquid within the stage body.

56-67. (canceled)
